(19) United States
(12) Patent Application Publication
(10) Pub. No.: US 2012/0066000 A1
(43) Pub. Date: Mar. 15, 2012

(54) CLINICAL DECISION SUPPORT SYSTEMS WITH EXTERNAL CONTEXT

(75) Inventors: Roland Opfer, Hamburg (DE); Ingwer C. Carlsen, Hamburg (DE); Autri Dutta, Croton On Hudson, NY (US); P. Karina Tulipano, Brooklyn, NY (US); Victor Vloemans, Rosmalen (NL); Lilla Boroczky, Mount Kisco, NY (US); Steffen Renisch, Hamburg (DE)

(73) Assignee: KONINKLIJKE PHILIPS ELECTRONICS N.V., EINDHOVEN (NL)

(21) Appl. No.: 13/320,700

(22) PCT Filed: Apr. 9, 2010
(86) PCT No.: PCT/IB2010/051543

§ 371 Date: Nov. 15, 2011

Related U.S. Application Data
(60) Provisional application No. 61/178,580, filed on May 15, 2009.

(51) Int. Cl. G06Q 50/24

(52) U.S. Cl. 705/3

(57) ABSTRACT

A clinical decision support (CDS) system comprises a patient treatment histories database (10, 32) and a patient case navigation tool (10, 30) operative to select a patient treatment history from the patient treatment histories database and to display a flowchart representation (50) of at least a portion of the selected patient treatment history. Optionally, the navigation tool (10, 30) is further operative to selectively display a flowchart representation (64, 66) of a portion or all of a patient nonspecific treatment guideline not coinciding with the selected patient treatment history. Optionally, the CDS system further comprises a patient records query engine (10, 40) operative to receive a query and apply same against the patient treatment histories database to retrieve query results, the navigation tool (10, 30) being further operative to generate a query responsive to user input and to display query results retrieved for the query.

The following relates to the medical arts, medical diagnostic arts, medical case management arts, expert system arts, and related arts.

Clinical decision support (CDS) systems are expert systems constructed to provide automated assistance to physicians or other medical personnel in making medical decisions such as ailment diagnosis, treatment selection, and implementation of various treatment regimen options such as dosing, cycles, and so forth. Some illustrative CDS systems are described, for example, in Alsafadi, U.S. Publ. Appl. No. 2007/0175980 A1.

A physician or other human medical diagnostician relies upon his or her past experiences in patient diagnoses and outcomes in making medical diagnoses and assessments of current patients. However, the physician may not have relevant past experience related to a particular current patient. Commonly, the physician may address this experiential deficiency by consultation with other physicians or by consulting standard medical texts or other relevant medical literature. In spite of these sources of information, reliance upon past experiences can be problematic due to limitations on the experience of any one physician (especially a newer physician with less total experience) and biases or memory gaps in individual physicians' anecdotal recollections.

A clinical decision support (CDS) system augments the knowledge of the physician or other human medical diagnostician by providing a database of past clinical experiences that may be more extensive and complete than the past experience of any particular physician or even the collective past experience of a group of physicians. The CDS system also includes expert system filtering or selection capability enabling the CDS system to “sort through” this database to retrieve and present the most relevant content as assessed by the filtering or selection algorithm of the CDS system.

In many instances, a physician or other human diagnostician may wish to know information about a current patient case, such as the treatment choices made, the progression of a patient, and so forth, from the beginning of treatment of the patient to the current time. Typically, this information is available as paper or electronic medical records. It is tedious for a physician to obtain information about the patient case history from these sources because the physician has to go through many lengthy documents which are not always chronologically ordered. Existing CDS systems generally do not provide patient case histories in a concise, readily accessible and understandable format.

The physician often would also like to query the CDS system based on the treatment pathway of the current patient, since the objective is often to investigate outcomes of patients who have undergone similar treatment. Existing CDS systems do not provide a convenient way to formulate such queries.

The following provides new and improved apparatuses and methods which overcome the above-referenced problems and others.

In accordance with one disclosed aspect, a clinical decision support (CDS) system comprises: a patient treatment histories database containing patient treatment histories; and a patient case navigation tool operative to select a patient treatment history from the patient treatment histories database and to display a flowchart representation of at least a portion of the selected patient treatment history and to additionally selectively display a flowchart representation of a portion or all of a patient nonspecific treatment guideline not coinciding with the selected patient treatment history.

In accordance with another disclosed aspect, a clinical decision support (CDS) system comprises: a patient treatment histories database containing patient treatment histories; a patient records query engine operative to receive a query and apply the received query against the patient treatment histories database to retrieve query results; and a patient case navigation tool operative to select a patient treatment history from the patient treatment histories database and to display a flowchart representation of at least a portion of the selected patient treatment history, and further operative to generate a query responsive to user input and to display query results retrieved by the patient records query engine for the query.

In accordance with another disclosed aspect, a clinical decision support (CDS) method comprises: selecting a patient treatment history from a patient treatment histories database containing patient treatment histories; displaying a flowchart representation of the selected patient treatment history; and responsive to user selection of an overview option, displaying an overview including a flowchart representation of at least a portion of the selected patient treatment history in context with a flowchart representation of a portion or all of a patient nonspecific treatment guideline not coinciding with the selected patient treatment history.

In accordance with another disclosed aspect, a storage medium is disclosed, the storage medium storing instructions executable by a digital processor to perform the clinical decision support (CDS) method set forth in the immediately preceding paragraph.

One advantage resides in a CDS system that provides patient information of varying scope ranging from statistical information

Another advantage resides in providing a user interface for manual grouping of similar patient cases in which the patient cases are represented by patient icons comprising patient images or thumbnail images generated from patient images.

Another advantage resides in automatically aggregating and correlating image and non-image features.

Further advantages will be apparent to those of ordinary skill in the art upon reading and understand the following detailed description.

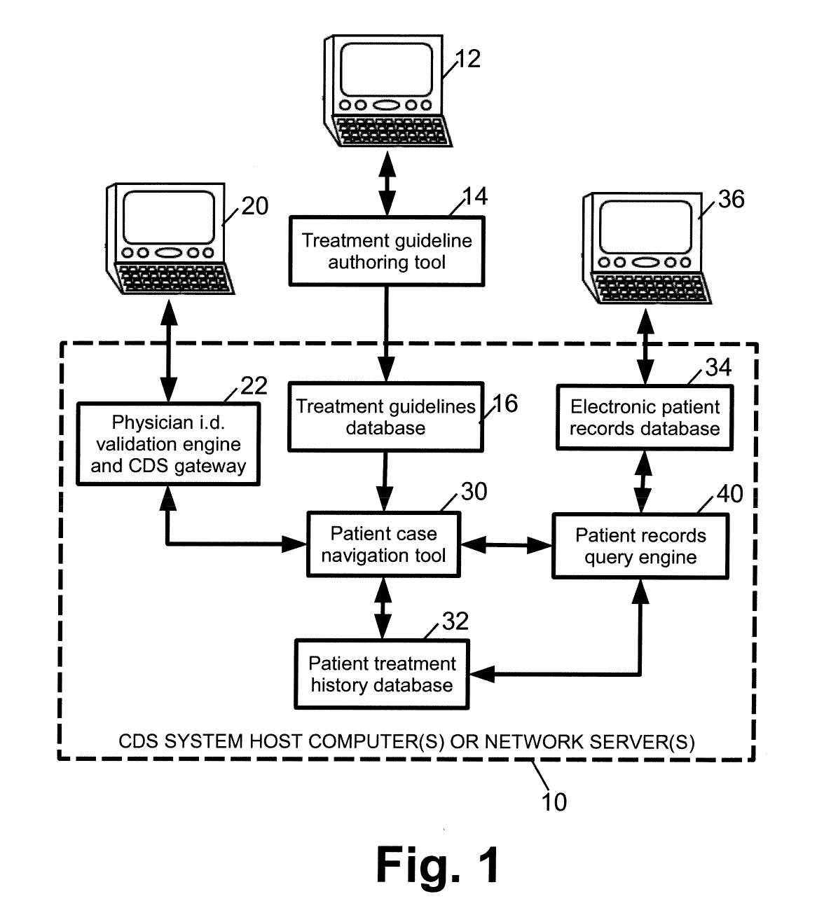

FIG. 1 diagrammatically shows a clinical decision support (CDS) system.

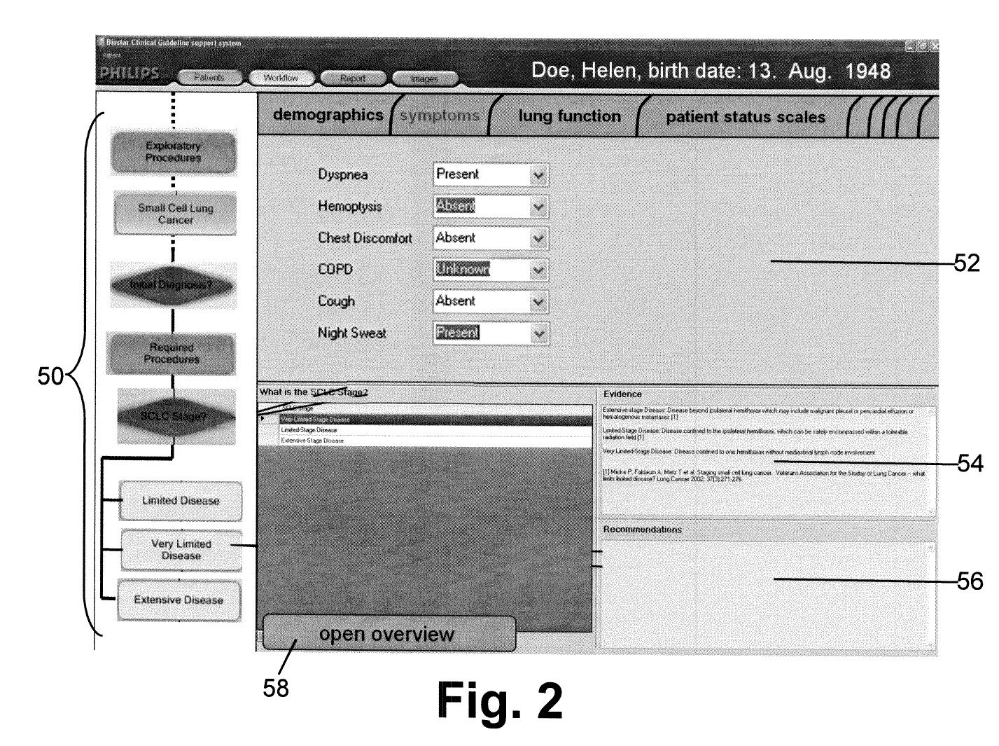

FIGS. 2-7 show display screenshots illustrating various aspects of the CDS system of FIG. 1.

With reference to FIG. 1, a clinical decision support (CDS) system is maintained on a suitable digital processing system 10, such as a CDS system host computer or computers, or a CDS system host network server or network servers, or so forth. The digital processing system 10 may in general be a single computer or network server, or may comprise a plurality of intercommunicating computers and/or network servers. Other digital processing devices or device combinations are also contemplated.

The CDS system employs treatment guidelines for supported medical conditions. Toward this end, a medically knowledgeable user operates a computer 12 or other user interface to interact with a treatment guideline authoring tool 14 in order to construct or optionally modify a treatment guideline for a medical condition that is stored in a treatment guidelines database 16. In general, a treatment guideline is constructed for each supported medical condition. The treatment guideline may in general include various decision points and alternative treatment pathways whose traversal for a specific patient case depends upon various test results, observed medical complications, physician decisions, and other factors. The treatment guideline can be represented as a flow diagram in which nodes correspond to medical operations (medical tests, therapeutic interventions, decision points, or so forth) and the nodes are interconnected to indicate the flow or progression of the patient within the clinical pathway including treatment regimen over time.

A physician or other medical person (hereinafter referred to without loss of generality as a physician) interacts with the CDS system via a computer 20 or other user interface (which may, in general, be the same as or different from the computer 12). By way of example, the physician accesses the CDS system through a physician identification validation engine and CDS gateway module 22 which ensures that the physician is an authorized user of the CDS system. The physician identification validation employs a suitable authentication tool such as a password-based authentication, a fingerprint reader, retinal scanner, or so forth. The physician identification validation engine and CDS gateway module 22 optionally tags or otherwise identifies the physician's CDS operating session so that the physician's interactions with the CDS system are personally associated with the physician.

Once verified, the physician interacts with the CDS system via a patient case navigation tool 30 which is operative to select a patient treatment history from a patient treatment histories database 32 and to display a flowchart representation of the selected patient treatment history. As with the treatment guidelines, the patient treatment history can be represented as a flowchart representation with nodes and connectors. In general, the patient treatment history coincides with a portion of a treatment guideline corresponding to the patient's medical condition. The patient treatment histories database 32 includes or has access to at least enough information in order to generate the flowchart representation of the patient treatment history and to retrieve other informatoin pertinent to clinical decision support. In the illustrated embodiment, the patient treatment histories database 32 is linked with or otherwise communicates with an electronic patient records database 34 into which physicians, nurses, or other medical personnel input medical information about the patient via a computer 36 or other user interface device (which may, in general, be the same as or different from the computers 12, 20). Alternatively, the patient treatment histories database 32 and the electronic patient records database 34 may be constructed in unitary fashion as a single database. In another contemplated configuration, the patient treatment histories database 32 and the electronic patient records database 34 are not intercommunicating or integrated together, and instead the physician maintains the patient treatment history stored in the patient treatment histories database 32 by inputting relevant patient information into the patient treatment histories database 32 via the patient case navigation tool 30.

The patient case navigation tool 30 also optionally has access to the treatment guidelines database 16. In such embodiments, the patient case navigation tool 30 can display a flowchart representation of the selected patient treatment history, and can additionally also selectably display an overview flowchart representation including a portion or all of the overall patient-nonspecific treatment guideline which does not coincide with the selected patient treatment history. By way of example, the overview flowchart representation display may include visually perceptible delineating of the portion that coincides with the selected patient treatment history, so that the physician can readily identify the portion of the overarching treatment guideline that has been traversed for the selected patient in the context of the overall treatment guideline.

In this way, the patient case navigation tool 30 can provide an overview of the patient treatment regimen including portions not yet reached in the treatment of the selected patient, or including alternative treatment paths not traversed in the treatment of the selected patient due to decisions made at earlier decision points. The overview can usefully inform a current clinical decision by providing the physician with knowledge of future treatment path options that may be eliminated or irrevocably selected by the current clinical decision. The overview can also usefully inform a current clinical decision by providing the physician with knowledge of alternative treatment paths that may have been bypassed by previous clinical decisions in the selected patient case, but which might be reconsidered in view of more recently obtained information or knowledge.

The patient case navigation tool 30 also optionally includes or communicates with a patient records query engine 40 that is operative to receive a query and apply the received query against the patient treatment histories database 32 to retrieve query results. The patient case navigation tool 30 is operative to generate a query responsive to user input and to display query results retrieved by the patient records query engine 40 for the query. The query results may be displayed as a graphical representation, such as a histogram, over a patient characteristic such as patient age, patient weight, patient gender, patient ethnicity, and patient outcome, or as another graphical statistical representation of the query results. By way of example, the patient case navigation tool 30 may generate a query responsive to user selection of a node of the flowchart representation of the selected patient treatment history, in which the generated query requests patient records for patient treatment histories in the patient treatment histories database 32 that include the selected node.

Additionally or alternatively, the patient records query engine 40 may receive a similar patient identification from the patient case navigation tool 30 and retrieve a complete medical history or other medical information about the similar patient from the patient treatment histories database 32. The medical history or other medical information about the similar patient is communicated back to the patient case navigation tool 30 for display to the physician. By way of example, the physician may select the similar patient from the statistical information retrieved by a query generated for a user-selected node.

The aspects of providing an overview flowchart representation of the patient-nonspecific treatment guideline including at least a portion not coinciding with the selected patient treatment history, on the one hand, and of providing the query engine 40 for retrieving information from the patient treatment histories database 32, on the other hand, can be usefully combined. By way of example, the overview flowchart representation graphically shows nodes corresponding to treatments, tests, or so forth which the selected patient has not traversed. The physician can select such a node for query via the query engine 40 so as to retrieve statistical information about other patients who have traversed the selected node. This provides the physician with substantial information about the selected node thus aiding the physician in deciding whether the selected patient's treatment flow should encompass the selected node. Further, if the physician identifies in the statistical information a similar patient (or a few similar patients) whose treatment histories appear to closely parallel that of the currently selected patient, the physician can optionally also use the query engine 40 to retrieve a medical history or other medical information about the similar patient from the patient treatment histories database 32.

It is to be understood that the various computer or digital data processing components 10, 12, 14, 20, 36 can be variously embodied. For example, the illustrated components 10, 12, 14, 20 can be embodied as a single computer that enables both configuration (e.g., treatment guideline authoring) and use of the CDS system. As another example, the components 10, 20 can be embodied together as an end-user CDS system, while the computer 12 and treatment guideline authoring tool 14 can be embodied as a separate CDS system configuration computer, in which case it is also contemplated for the configuration system 12, 14 to be located remotely from the end-user system 10, 20. As an example of this latter arrangement, the configuration system 12, 14 may be located at a CDS system vendor site, while the end-user system 10, 20 may be located at a hospital or other medical facility. It will also be appreciated that the disclosed CDS systems and methods may be embodied by a storage medium such as a magnetic disk, optical disk, random access memory (RAM), read-only memory (ROM), or so forth that stores instructions executable by a digital processor such as the illustrated processing components 10, 12, 14, 20, 36 to perform a disclosed CDS method.

The illustrative CDS system 10 shown in FIG. 1 is further described with reference to selected illustrative display screenshots shown in FIGS. 2-8.

FIG. 2 shows a screenshot taken after loading of a selected patient treatment history. A flowchart representation 50 of the selected patient treatment history is displayed in a lefthand window or screen portion. The flowchart representation 50 shown in FIG. 2 depicts only a relevant portion of the selected patient treatment history. This selected portion includes a number of nodes indicating interventions, decisions, or the like that have already occurred. Accordingly, these nodes are said to have been “already traversed” by the treatment regimen for the selected patient. The flowchart representation 50 of FIG. 2 also shows one or more nodes representing the next step in the treatment regimen. It is to be understood that the selected patient treatment history represented by the flowchart representation 50 coincides with a portion of a patient nonspecific treatment guideline for SCLC (not shown in FIG. 2) stored in the treatment guidelines database 16. The patient nonspecific SCLC treatment guideline defines the nodes of the flowchart representation 50. Patient-specific information such as identification of the already-traversed nodes and associated patient test results, clinical decisions for the selected patient, or so forth, are stored in the patient treatment history database 32 in the file or other data structure corresponding to the selected patient.

In the flowchart representation 50 of FIG. 2, the already-traversed nodes are shown with darkened backgrounds to indicate nodes already traversed in the treatment of the selected patient. Instead of darkened backgrounds, other visually perceptible delineation can be used, such as using a delineating color for the bounding lines, fill area, background, and/or text of the already-traversed nodes, using a delineating line pattern (for example, a solid line or a broken, dashed, or dotted line) for bounding lines of the already-traversed nodes, using all-capital letters, boldface, or another distinct typefont for the already-traversed nodes, or so forth. In the illustrative example of FIG. 2, the already-traversed nodes include: a node labeled “Exploratory Procedures” indicating exploratory surgical procedures that have been performed on the selected patient; a node labeled “Small Cell Lung Cancer” indicating a clinical decision support output proposing that the exploratory procedures are suggestive of small cell lung cancer; a decision node labeled “Initial Diagnosis?” at which the physician confirms the suggested diagnosis of small cell lung cancer; a node labeled “Required Procedures” indicating certain medical procedures that are generally considered appropriate for a patient diagnosed with small cell lung cancer; and a decision node labeled “SCLC Stage?” where the acryonym “SCLC” represents “small cell lung cancer” and the node represents the physician's decision as to the stage of the selected patient's SCLC.

In the flowchart representation 50 of FIG. 2, the one or more nodes representing the possible stages of SCLC which the physician may select in accordance with the patient-nonspecific SCLC treatment guideline. In the illustrative example, these stage options are represented by the following nodes: a node labeled “Limited Disease” indicating a decision that the selected patient is in the limited SCLC stage; a node labeled “Very Limited Disease” indicating a decision that the selected patient is in the very limited SCLC stage; and a node labeled “Extensive Disease” indicating a decision that the selected patient is in the extensive SCLC stage. These nodes have not yet been traversed, since the physician has not yet decided the stage of the selected patient's SCLC. In other words, the decision node labeled “SCLC Stage?” can be considered as the “current” node that is being traversed currently, with the decision representing the next node to be traversed.

It will be appreciated that the physicians clinical decision regarding the SCLC stage will determine future treatment of the selected patient. Based on the physician's clinical decision, only one of the nodes labeled “Very Limited Disease”, “Limited Disease”, or “Extensive Disease” will be traversed, while the other two will be bypassed. Future treatment is dependent upon this clinical decision.

To assist the physician in making this decision, relevant patient-specific information is provided in an additional windows 52 shown in the righthand side of the screenshot of FIG. 2. In the illustrative example, this patient-specific information includes: information on dyspnea (which is present in the selected patient); information on hemoptysis (which is absent in the selected patient); information on chest discomfort (which is absent in the selected patient); information on chronic obstructive pulmonary disease (COPD, whose presence is unknown in the selected patient); information on cough (which is absent in the selected patient); and information on night sweat (which is present in the selected patient). Further, general definitions and patient-nonspecific advice for making the decision is listed in a window 54 located below the patient information window 52. Still further, a window 56 provides a patient-specific clinical decision support recommendation if such a recommendation is generated by the CDS system based on the available patient information. In the illustrative example of FIG. 2, the CDS system has not generated a recommendation at the time of the screenshot of FIG. 2, and accordingly the window 56 is empty in FIG. 2.

As already noted, future treatment for the selected patient is dependent upon the clinical decision to be made at the current node labeled “SCLC stage?”. However, the future treatment is not shown in the flowchart representation 50 of the selected patient treatment history shown in FIG. 2. In theory, this should not be a problem because the decision of SCLC stage should in theory be determined solely based on information about the selected patient (for example, such as is provided in the window 52) and on definitional and related information about the stages provided in the window 54, possibly augmented by the CDS system recommendation (if any) provided in the window 56. Indeed, one conventionally perceived benefit of using a CDS system is that it assists the physician in focusing on the current clinical decision to be made for the selected patient.

In practice, however, it is recognized herein that the physician might want to know what future treatment is indicated in the patient-nonspecific SCLC treatment guideline for each of the possible decisions. For example, if the selected patient is frail the physician might want to know whether the SCLC treatment guideline for “Extensive Disease” entails aggressive therapies such as surgery or aggressive chemotherapy that the frail patient may be unable to withstand.

Further, depending upon the progress being made (or not being made) with the selected patient, the physician might begin to become uncomfortable with a decision made at an already-traversed node. For example, if what the physician is seeing for the selected patient (for example, as reflected in the patient-specific information set forth in the window 52) seems to the physician to be inconsistent with SCLC, then the physician might want to take a look back at the already-traversed “Initial Diagnosis?” decision node, to see what other diagnoses may have been available. Again, this information is not provided in the flowchart representation 50 of the selected patient treatment history shown in FIG. 2 which focuses on the SCLC stage decision node.

It is recognized herein that in some instances the physician may want to have a more overarching view of future and/or past patient therapy options in order to better inform the current decision, or to enable reconsideration of past decisions made at already-traversed nodes. It is recognized herein that it is advantageous to provide the physician with the option of relaxing the conventional focus of the CDS system.

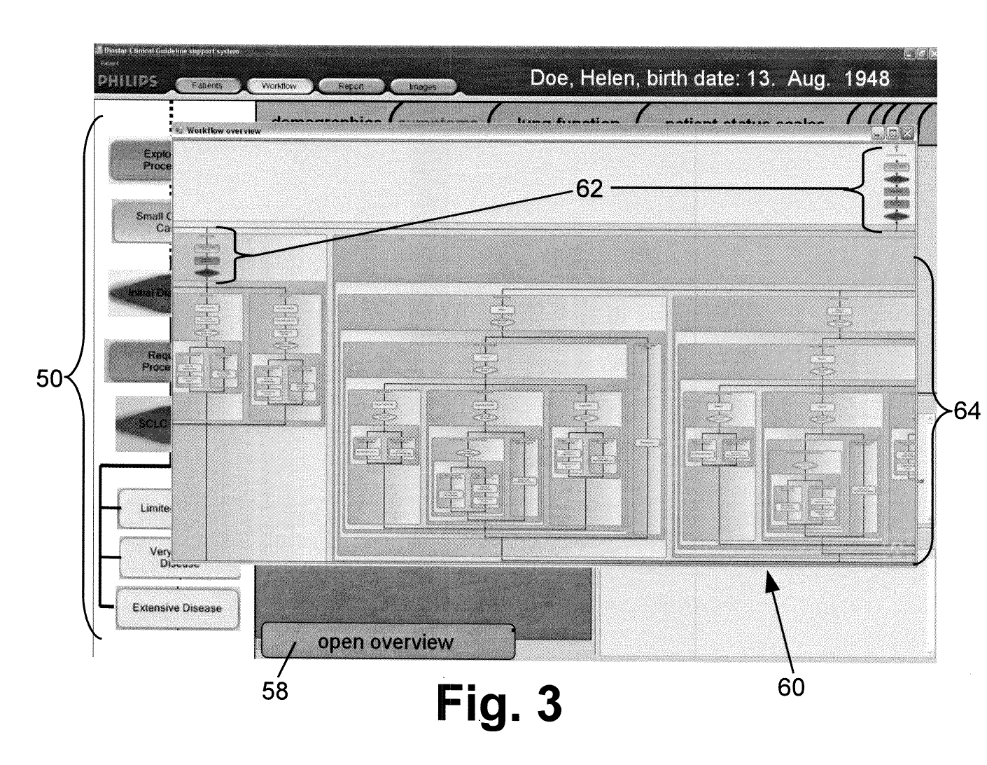

With continuing reference to FIG. 2 and with further reference to FIG. 3, toward this end the display shown in FIG. 2 provides the physician with an overview selection button 58 which the physician can select using a mouse pointer, or by pressing a hotkey or hotkey combination, or by another user selection input. Upon selection by the user of the overview selection button 58, a overview view 60 is provided in a pop-up window, as shown in FIG. 3, or in another area of the display. In some embodiments, a separate monitor or other separate display device may be used to display the overview view 60. The illustrated overview view 60 shows a flowchart representation 62 of the selected patient treatment history displayed together with and in context with a flowchart representation 64 of a portion or all of the patient-nonspecific treatment guideline not coinciding with the selected patient treatment history. In FIG. 3, the complete patient-nonspecific SCLC treatment guideline is illustrated by the flowchart representation 64. The complete SCLC treatment guideline is complex and includes decision nodes and numerous branches holistically representing the various treatment options, procedures, and so forth that may be appropriate for various SCLC stages, various possible patient-specific complications, and so forth. As a result, the flowchart representation 64 of the complete SCLC treatment guideline shown in FIG. 3 is difficult to read.

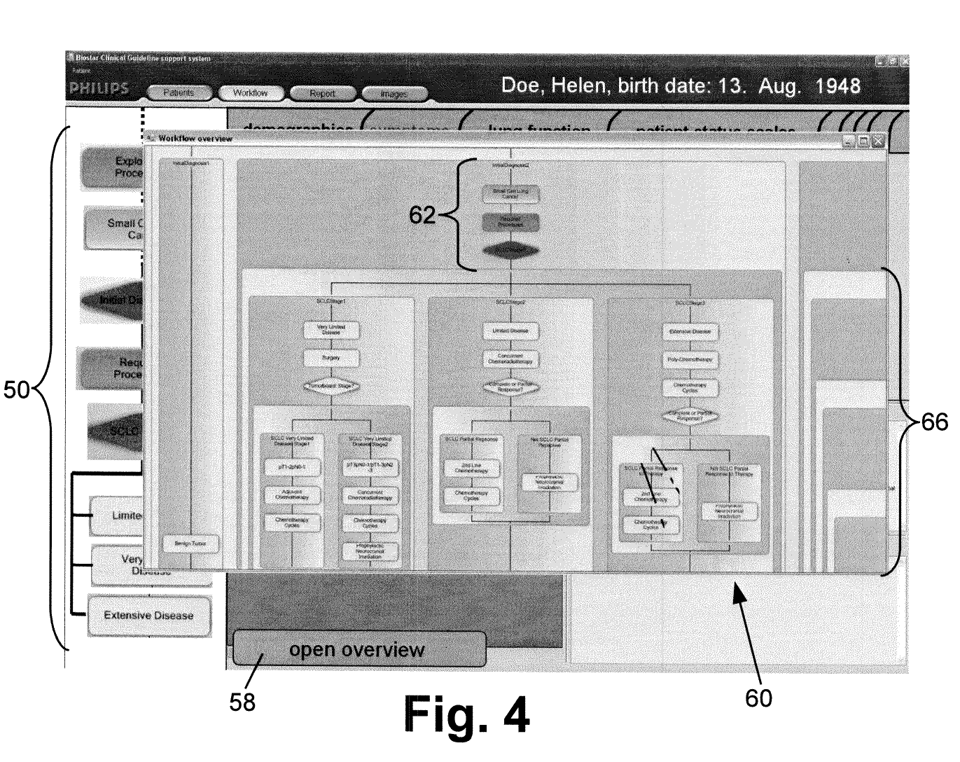

With reference to FIG. 4, the overview view 60 optionally allows the physician to use graphical user interface (GUI) window manipulations such as pan, zoom, or so forth selected using a mouse, keyboard, or other user input device in order to enlarge selected portions of the treatment guideline. In the illustrative screenshot of FIG. 4, the user has panned to move the leftmost portion of the flowchart representation 64 of FIG. 3 to center and has zoomed to enlarge this portion, thus producing the flowchart representation of a panned and zoomed portion of the SCLC treatment guideline. The flowchart representation shown in FIG. 4 focuses in on the portion of the SCLC treatment guideline coinciding with the flowchart representation 62 of the selected patient treatment history together with a flowchart representation 66 including future treatment options that become available depending upon the SCLC stage to be selected by the physician at the current “SCLC stage?” decision node. In the overview view shown in FIG. 4, for example, the physician can readily see that: (i) selection of the “Very Limited Disease” SCLC stage would entail treatment including surgery; (ii) selection of the “Limited Disease” SCLC stage would entail treatment including concurrent chemoradiotherapy; and (iii) selection of the “Extensive Disease” SCLC stage would entail treatment including poly-chemotherapy with a plurality of chemotherapy cycles. The physician can now make an informed decision as to whether, for example, the selected patient, if frail, would be likely to be able to undergo the therapy indicated for the “Extensive Disease” SCLC stage, which would entail aggressive chemotherapy as set forth in the flowchart representation 66 of FIG. 4.

The CDS system described with reference to FIGS. 1-4 advantageously provides a graphical representation 50 of the patient's clinical pathway. The patient's clinical pathway is the patient's actual record of treatment. The graphical representation 50 allows the physician to obtain a quick overview about already performed treatment/diagnosis steps and future treatment options for an individual patient. In addition, the CDS system advantageously provides an alternative representation (FIGS. 3 and 4) in which the path is presented as a patient-specific navigation through a tree where the tree represents the entire set of treatment options available in the clinical guideline. The particular path represents the particular choices made for each node of the clinical guideline as the patient was treated.

The overview capability of the patient case navigation tool 30 described with illustrative reference to the screenshot examples shown in FIGS. 3 and 4 provides the physician with useful overview information which can be used to better inform the current decision, or to enable reconsideration of past decisions made at already-traversed nodes. In most instances, the physician is expected to continue on with the treatment plan of the selected patient by making the decision or other action corresponding to the current node in accordance with the patient nonspecific treatment plan. In the illustrative example, for instance, the physician will most likely select the appropriate SCLC stage for the selected patient, and treatment will continue onward in accordance with the treatment operations indicated by the SCLC treatment guideline for the selected SCLC stage. Thus, in most cases the physician will ultimately make the clinical decision indicated at the current decision node, optionally after reviewing the overview view 60 to place the clinical decision to be made into context of the overarching treatment guidelines.

In making the clinical decision, the physician is likely to be guided by the physician's past experience with patients having similar cases. Toward this end, the physian may consult medical records of current or past SCLC patients who are or have been under the medical care of the physician. The physician may also consult case studies reported in the medical literature, or may consult with other physicians to mine relevant knowledge these other physicians have gleaned from their current or past SCLC patients.

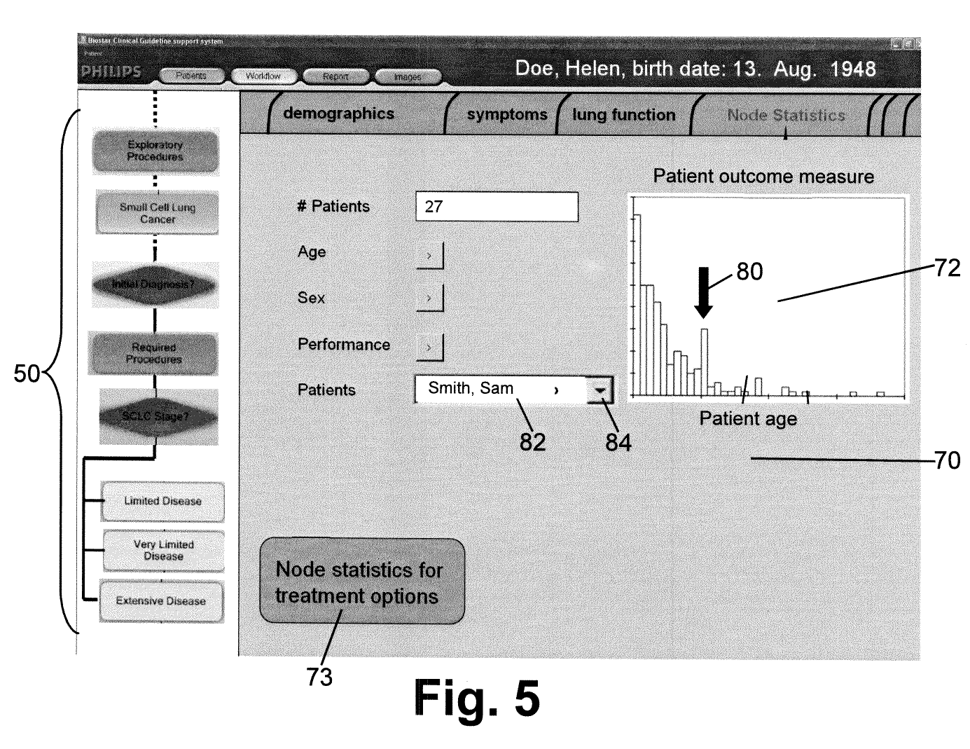

With reference back to FIGS. 1 and 2 and with further reference to FIG. 5, the illustrative CDS system provides another source of patient case information for consideration by the physician in making the clinical decision. It is recognized herein that the patient treatment history database 32 provides a database of patient case histories, some of which are likely to have had SCLC and some of which may be probative for the physician in making the current SCLC stage decision for the selected patient. Toward this end, the patient records query engine 40 is operative to receive a query requesting patients who have traversed a node of interest, such as the “SCLC stage?” decision node. The patient records query engine 40 applies this query against the patient treatment histories database 32 to retrieve as query results information pertaining to those patients who have had SCLC and for whom the “SCLC stage?” decision node has been traversed. By way of example, FIG. 5 shows a window 70 which displays statistical results for twenty-seven patients whose case histories have traversed the “SCLC stage?” decision node. In the illustrative example, the statistic of “patient outcome measure” is shown as a histogram 72 over the patient characteristic of “patient age”. The patient outcome measure can employ any suitable quantitative measure of patient outcome. More generally, various statistical information can be displayed in various ways, such as in a table, as a pie chart, or so forth, and the statistical information can be over various patient characteristics of interest, such as patient age, patient weight, patient gender, patient ethnicity, patient outcome, or so forth.

The histogram 72 of FIG. 5 shows outcomes for all patients whose treatment history traversed the “SCLC stage?” decision node. This information may be useful to the physician for various purposes such as deciding whether the current treatment path should be continued, or for advising the patient. However, for the purpose of deciding to which SCLC stage the selected patient should be assigned, histograms or other statistical aggregated representations focused on patients assigned to the various SCLC stages may be of substantial value.

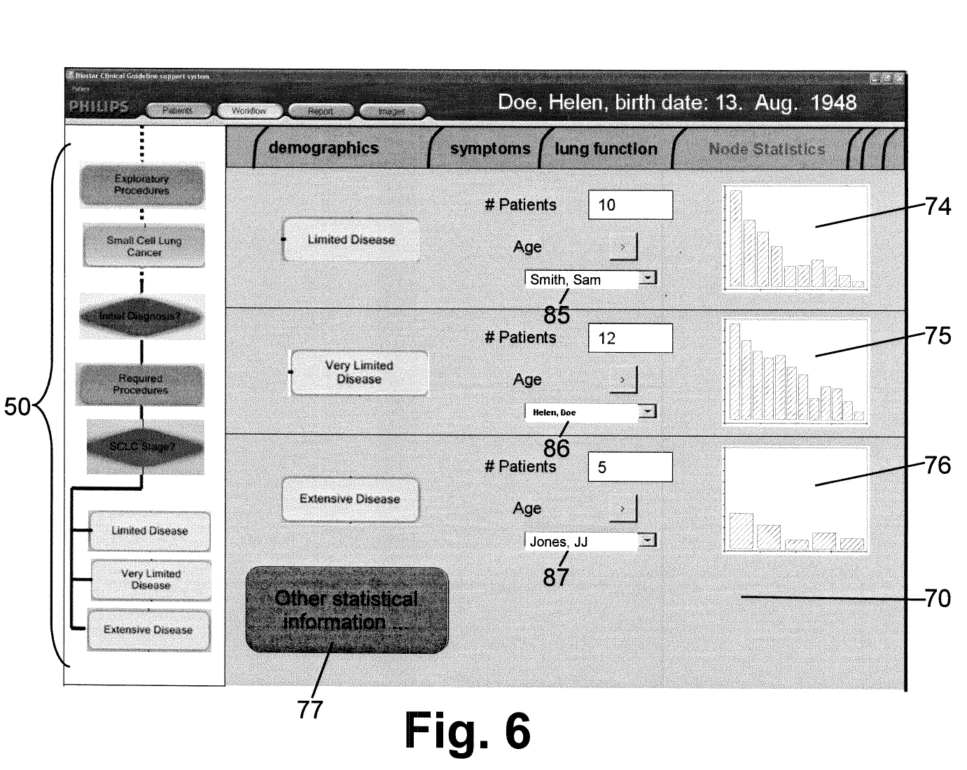

With continuing reference to FIG. 5 and with further reference to FIG. 6, to provide additional useful information for deciding to which SCLC stage the selected patient should be assigned, the display shown in FIG. 5 provides the physician with a “node statistics for treatment options” selection button 73 which the physician can select using a mouse pointer, or by pressing a hotkey or hotkey combination, or by another user selection input. Upon selection by the user of the selection button 73, the screen shown in FIG. 6 is generated, in which the window 70 is redrawn to show separate outcome statistic histograms 74, 75, 76 over patient age for the the possible SCLC stages of “Limited Disease”, “Very Limited Disease”, and “Extensive Disease”, respectively. This information is more probative for deciding to which SCLC stage the selected patient should be assigned as compared with the aggregated information of the histogram 72 of FIG. 5. Optionally, another selection button 77 labeled “Other statistical information . . . ” can be selected to bring up a dialog window (not shown) via which the physician can select other statistical information over other patient characteristics.

The statistical information provided in the window 70, such as the various histograms 72, 74, 75, 76, can be useful to the physician in making the current clinical decision. These statistics summarize a substantial number of patient cases (twenty-seven patient cases in the histogram 72, for example) and the constituent patient cases may have clinically significant differences as compared with the selected patient to which the current clinical decision pertains.

In some instances, however, the physician may want to focus in on information pertaining to a particular similar patient case of interest, rather than viewing a histogram or other statistical aggregated representation of information pertaining to numerous similar patients.

For example, with particular reference now being directed to FIG. 5, the presented statistical information may enable the physician to identify a patient case history that may be of especial relevance to the current clinical decision. For example, in FIG. 5 the physician employs a “down-arrow” cursor 80 to identify a particular datum in the histogram 72 which appears the physician to be of particular interest. By way of example, the particular datum selected using the cursor 80 has a higher patient outcome measure than the surrounding data, and may correspond to a patient age close to the age of the selected patient to whom the current decision pertains. The personal name or other identification of the patient selected using the cursor 80 is identified in a text user interface dialog 82 as “Smith, Sam”. In some embodiments, the patient identification may be anonymized to protect patient privacy, for example by replacing “Smith, Sam” by “Patient # 474” or the like. In some embodiments, the patient identification may be tied with the physician identification input by the physician via the physician identification validation engine and CDS gateway 22 (see FIG. 1)—in these embodiments, the patient's personal name is shown in the text user interface dialog 82 if the patient is under the physician's care or otherwise is allowed to be known to the physician, and is anonymized otherwise. In embodiments, the text user interface dialog 82 also includes a drop-down list selection button 84 that enables the physician to browse the list of personal patient names (or the sub-list of personal patient names that are allowed to be viewed by the identified physician). This browsing mode can be useful to help jog the physician's memory to recall by patient name similar cases.

With continuing reference to FIG. 5 and with brief reference to FIG. 6, each of the SCLC stage display portions shown in FIG. 6 optionally include a corresponding text user interface dialog 85, 86, 87 operatively similar to the text user interface dialog 82 of FIG. 5 but limited to patients assigned to the corresponding SCLC stage, to enable selection or browsing of patients having each particular stage. Although not illustrated, the cursor 80 shown in FIG. 5 can also have an analog in each of the stage-specific histograms 74, 75, 76.

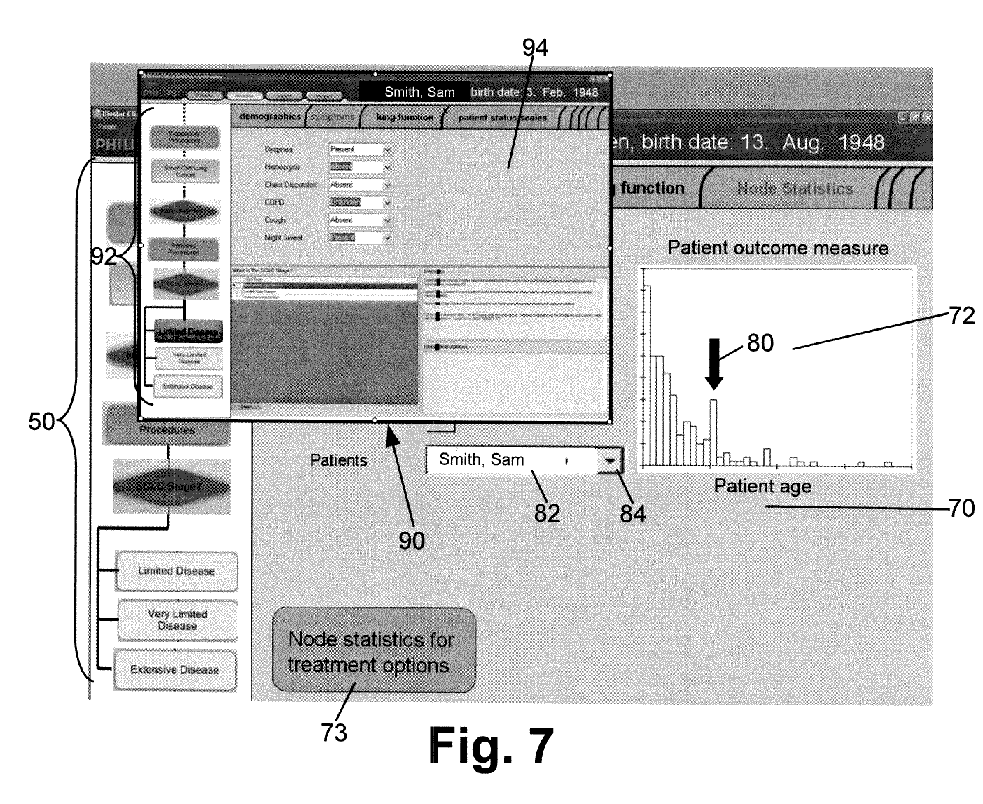

With reference to FIG. 7, selection of a similar patient treatment history by personal name or by patient identification number or the like using the text user interface dialog 82 optionally brings up further information about the similar patient. By way of example, FIG. 7 shows a pop-up window 90 containing information about the similar patient “Smith, Sam” selected via the text user interface dialog 82. This information is advantageously displayed in a format similar to that of FIG. 2, but containing information for the similar patient “Smith, Sam”. By way of example, the treatment history for the similar patient is graphically displayed using a flowchart representation 92, and a window 94 presents patient-specific information for the similar patient “Smith, Sam”. Advantageously, the same display algorithms of the patient case navigation tool 30 (see FIG. 1) that are used to generate the display of FIG. 2 can be used to generate the content of the pop-up window 90 pertaining to the similar patient “Smith, Sam”. Note that in the pop-up window 90 the SCLC stage “Limited Disease” is indicated as an already-traversed node, since the patient treatment history of the similar patient “Smith, Sam” has already traversed this decision and similar patient “Smith, Sam” was assigned the SCLC stage “Limited Disease”. Depending upon how similar patient “Smith, Sam” actually is to the selected patient, as indicated by way of example by comparison of the content of the window 94 with the window 52 (see FIG. 2) for the selected patient, the physician may find the information on similar patient “Smith, Sam” shown in pop-up window 90 highly probative for making the SCLC stage decision for the selected patient.

The content of the pop-up window 90 is shown using a format similar to that of FIG. 2, and may indeed be generated by the patient case navigation tool 30 of the CDS system. However, it is contemplated to display the illustrated or other information about the similar patient using other formats. For example, in some embodiments the selection of a similar patient using one of the text user interface dialogs 82, 85, 86, 87 or using another user input is contemplated to bring up a complete medical history for the similar patient.

The illustrative similar patient “Smith, Sam” is a patient of the physician or, alternatively, the physician is otherwise authorized to view personal medical information for similar patient “Smith, Sam”. However, in embodiments and circumstances in which patient privacy is to be maintained, personalizing information such as names, and other private patient medical information, is suitably redacted or anonymized in the pop-up window 90 or other display of similar patient information.

The CDS system described with reference to FIGS. 1, 2, and 5-7 advantageously includes an integrated database query mechanism that enables retrieval of node statistics for each treatment/diagnosis node of the guideline. By a mouse click on the “node statistics” panel (or other user-controlled selection operation) a database search by the patient records query engine 40 is triggered. One or more local databases 32, 34 are searched for information regarding all patients which have passed this decision node in the past. A list of these patients is shown to the user. In the illustrated embodiments, the text user interface dialog 82 provides this list in the form of a drop-down list selection dialog. In addition various statistics over this patient collective such as mean survival rate, histogram over age, or so forth is provided (see illustrative histogram 72 of FIG. 5). Optionally, the pulled patient collective can be split according to the guideline treatment/diagnosis options (see histograms 74, 75, 76 of FIG. 6). Optionally, cross reference to data about a specific patient of interest identified from the retrieved patient list 82 can also be provided, as illustrated for patient “Smith, Sam” in FIG. 7.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. A clinical decision support (CDS) system comprising:
a patient treatment histories database (10, 32) containing patient treatment histories; and
a patient case navigation tool (10, 30) operative to select a patient treatment history from the patient treatment histories database and to display a flowchart representation (50) of at least a portion of the selected patient treatment history and to additionally selectively display a flowchart representation (64, 66) of a portion or all of a patient-nonspecific treatment guideline not coinciding with the selected patient treatment history.

2. The CDS system as set forth in claim 1, further comprising:
a patient records query engine (10, 40) operative to receive a query from the patient case navigation tool, apply the received query against the patient treatment histories database (10, 32) to retrieve query results, and to communicate the query results to the patient case navigation tool (10, 30);
wherein the patient case navigation tool is further operative to generate the query responsive to user input and to display the query results.

3. The CDS system as set forth in claim 2, wherein the patient case navigation tool (10, 30) is operative to display the query results as a statistical aggregated representation (72, 74, 75, 76) over a patient characteristic.

4. The CDS system as set forth in claim 3, wherein the patient characteristic is selected from a group consisting of personalized characteristics such as patient age, patient weight, patient gender, patient ethnicity, and patient outcome.

5. The CDS system as set forth in claim 2, wherein the patient case navigation tool (10, 30) is operative to display the query results as a graphical statistical representation (72, 74, 75, 76) of the query results.

6. The CDS system as set forth in claim 1, further comprising:
a patient records query engine (10, 40) operative to receive a similar patient identification from the patient case navigation tool (10, 30), retrieve medical information about the similar patient from the patient treatment histories database (10, 32), and to communicate the medical information about the similar patient to the patient case navigation tool;
wherein the patient case navigation tool is further operative to generate the similar patient identification responsive to user input and to display the retrieved medical information about the similar patient.

7. The CDS system as set forth in claim 6, further comprising:
a user validation engine (10, 22) operative to validate user identity, wherein the patient records query engine (10, 40) and the patient case navigation tool (10, 30) anonymize the patient identification of the similar patient unless the validated user identity authorizes the user to access medical information about the similar patient.

8. The CDS system as set forth in claim 6, wherein:
the patient records query engine (10, 40) is further operative to receive a query from the patient case navigation tool (10, 30), apply the received query against the patient treatment histories database (10, 32) to retrieve query results, and to communicate the query results including identifications of patients satisfying the query and medical information corresponding to the patients satisfying the query to the patient case navigation tool; and
the patient case navigation tool is further operative to generate the query responsive to user input and to display the query results including patient identifications and to generate the similar patient identification responsive to user selection of a patient identification retrieved by the query.

9. The CDS system as set forth in claim 1, wherein the patient case navigation tool (10, 30) is operative to selectably switch between:
a patient treatment history view in which the flowchart representation (50) of the selected patient treatment history is displayed alone; and
an overview view (60) in which the flowchart representation (62) of the selected patient treatment history is displayed together with and in context with a flowchart representation (64, 66) of a portion or all of the patient-nonspecific treatment guideline not coinciding with the selected patient treatment history.

10. The CDS system as set forth in claim 9, where in the overview view (60) is displayed with the flowchart representation portion (62) coinciding with the selected patient treatment history visually perceptibly delineated.

11. The CDS system as set forth in claim 9, where in the overview view (60) the flowchart representation (66) of a portion or all of the patient-nonspecific treatment guideline not coinciding with the selected patient treatment history includes a portion of the patient-nonspecific treatment guideline after the selected patient treatment history in the flowchart.

12. A clinical decision support (CDS) system comprising:
a patient treatment histories database (10, 32) containing patient treatment histories;
a patient records query engine (10, 40) operative to receive a query and apply the received query against the patient treatment histories database to retrieve query results; and
a patient case navigation tool (10, 30) operative to select a patient treatment history from the patient treatment histories database and to display a flowchart representation (50) of at least a portion of the selected patient treatment history, and further operative to generate a query responsive to user input and to display query results retrieved by the patient records query engine for the query.

13. The CDS system as set forth in claim 12, wherein the patient case navigation tool (10, 30) is operative to generate a query responsive to user selection of a node of the flowchart representation (50) of the selected patient treatment history requesting information pertaining to patient treatment histories including the selected node.

14. The CDS system as set forth in claim 12, wherein the patient case navigation tool (10, 30) is operative to display the query results as a graphical statistical representation (72, 74, 75, 76) of the query results.

15. The CDS system as set forth in claim 14, wherein the resultant query is presented as a graphical statistical representation (72, 74, 75, 76) over a patient characteristic.

16. A clinical decision support (CDS) method comprising:
selecting a patient treatment history from a patient treatment histories database (10, 32) containing patient treatment histories;
displaying a flowchart representation (50) of the selected patient treatment history; and
responsive to user selection of an overview option (58), displaying an overview including a flowchart representation (62) of at least a portion of the selected patient treatment history in context with a flowchart representation (64, 66) of a portion or all of a patient-nonspecific treatment guideline not coinciding with the selected patient treatment history.

17. The CDS method as set forth in claim 16, further comprising:
visually perceptibly delineating the flowchart representation (62) of the selected patient treatment history from the context of the flowchart representation (64, 66) of a portion or all of a patient-nonspecific treatment guideline not coinciding with the selected patient treatment history.

18. The CDS method as set forth in claim 16, further comprising:
querying the patient treatment histories database (10, 32) respective to a user-selected node of a displayed flowchart representation (50, 62, 64, 66) to retrieve patient information for patient treatment histories that include the selected node; and
displaying the retrieved patient information or a statistical representation thereof.

19. The CDS method as set forth in claim 18, further comprising:
displaying patient medical information for a patient selected by a user from the displayed retrieved patient information or statistical representation thereof.

20. A storage medium storing instructions executable by a digital processor (10) to perform the CDS method set forth in claim 16.
